(19) United States
(12) Patent Application Publication
(10) Pub. No.: US 2003/0155067 A1
(43) Pub. Date: Aug. 21, 2003

(54) Method and article for masking portions of a vehicle by adherent appliques

(76) Inventor: John Syron, Grand Blanc, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/366,849

(22) Filed: Feb. 14, 2003

Related U.S. Application Data
(60) Provisional application No. 60/357,551, filed on Feb. 15, 2002.

(51) Int. Cl. B32B 31/00

(52) U.S. Cl. 156/252; 156/256; 118/505

(57) ABSTRACT

The present invention is a system and method for creating and applying a plurality of masking sections to portions of a vehicle to mask the same during painting of other and adjacent portions of the vehicle. Each of the plurality of individual sections being constructed of a plasticized material having a specified shape and thickness and including a backing surface. The backing surface is adherently applied to a specified location of the vehicle and in order to mask a surface of the vehicle at that location and during such as applying a single or two tone coat of paint.

### CROSS REFERENCE TO RELATED APPLICATIONS

The present application claims priority of U.S. Provisional Application Serial No. 60/357,551, filed Feb. 15, 2002, and entitled Method and Article for Masking Portions of a Vehicle by Adherent Appliqués.

### BACKGROUND OF THE INVENTION

1. Field of the Invention

The invention relates generally to masking larger sized articles of manufacture, such as motor vehicles, appliances, furniture and the like. More specifically, the present invention teaches a method and article for masking portions of vehicles and the like for the purpose of painting other and adjacent (uncovered) portions of the vehicle and without accidentally painting those portions which are masked.

2. Description of the Prior Art

When repairing scratches and other defects in the paint of a vehicle, it is not necessary to repair or repaint the entire vehicle. Masking products, such as films and bags, have been utilized in the art to cover the well-painted area of the vehicle and to expose only the area which is in need of painting/repair. Similarly, and such as during a two tone (TuTone) painting processes, such masking products are used to cover the exterior components of the vehicle exhibiting a first or primary color, thereby exposing only the areas to be painted with a secondary or coordinating color. A particular TuTone application is the painting of a bottom most strip of a vehicle body in a first selected color and, extending from its front to rear end, following which the remaining and upper body portion of the vehicle is then painted a secondary color.

Problems associated with existing technology include, in one instance, the significant time investment needed to tape the masking bag or film in place about the vehicle or other larger sized article. Additionally, and in certain circumstances, the tape does not hold the bag or film in place, causing it to detach during the painting process. Furthermore, several specialized processes will not permit the use of masking bags or film, which are taped in place.

Some manufacturing processes employed in the relevant art require that the masking product be removed prior to the application of a final clear coat. In such two tone painting applications, the coordinating color is painted, baked, and masked, following which the main color is then painted, the mask removed, and the entire vehicle clear coated and then baked. The above process, as well as other “wet pull” processes, require a product which can be easily applied and which, in given applications, will impart a relatively thin “break line” between adjoining colors, as well as be easily removable.

An additional example of a masking method and device is illustrated in U.S. Pat. No. 5,885,395, issued to Western, and which teaches painting a vehicle having adjacent body panels with a gap therebetween and in such a way as to prevent overspray from entering the gap. The method includes adhering one edge of a foamed plastics strip to the vehicle in the region of the gap, forming a loop longitudinally of the strip so that the loop lies within the gap substantially parallel therewith and applying a paint spray to the panel or panels, whereby the looped strip prevents paint from entering the gap. A foamed strip is also described and which is constructed of a web of foamed plastics material having adhesive applied to opposite faces of the strip, the adhesive being confined to an area close to an edge of the strip.

Although not related to a masking system, U.S. Pat. No. 6,183,580, issued to Harrell, teaches a protective covering system for protecting an exterior of a vehicle, including such as paint surfaces and glass surfaces, from damage resulting from rocks, insects, road tar, and other debris. The protective covering system includes a set of protective sheets, each exhibiting front and back surfaces and an outer perimeter. Each sheet is further generally transparent to permit passage of light therethrough between the front and back surfaces of the protective sheet. The back surface of each protective sheet is designed for attachment to an exterior surface of a vehicle.

### SUMMARY OF THE PRESENT INVENTION

The present invention discloses a plurality of individual, typically die cut, strips or sections of adhesive and/or magnetic backed film, as well as a related method of manufacture and application. In particular, the strips are applied to portions of the vehicle to mask them during painting of other and adjacent (uncovered) portions of the vehicle and without accidentally painting the masked portions, such as potentially occurring upon accidental overspray of paint by a robot or human operator.

The film is constructed of a moisture impervious polypropylene or polyethylene material, or other suitable rubberized and/or moisture impervious material, typically in sheet or roll form with a selected length and width, as well as a thickness preferably ranging between 1.0 mil to 6 mils. In a preferred application, the film may include a number of different materials exhibiting different thicknesses, among them including polyethylene, polypropylene, blends of both materials, and upon which may be applied any adhesive, including an acrylic-based or rubber-based adhesive.

The individual sections or strips of film may be cut to size to neatly fit over an associated body panel of the vehicle, and such as a conventional and numerically controlled die cut operation may be employed in combination with the sheet or roll of film to quickly and effectively turn out the desired shaped sections. Additional features such as pull tabs or loops can be employed into each individual section or strip and in order to facilitate removal of the masking portions.

Alternatively, a larger sized roll, oftentimes upwards of several feet wide or more and containing any quantity of lineal feet of material, is provided and may be sectioned or cut into smaller sized rolls, each exhibiting a desired width and for a given application. Other and additional types of roll sectioning processes include kiss stamping and rotary cutting of the desired panel shape from the roll of material.

A backing surface of the film further exhibits, in one application, an adhesive or tacking surface such as a non-silicone material which is applied and which will not transfer to the painted surface in use. A peel away backing layer may also be applied to the sectioned material, or roll of material, and which, upon being removed will reveal the adhesive backed layer. In a further application, a substrate is provided and upon which is adhesively secured a film surface to create a desired appliqué material.

In a further application, one or more magnets may be affixed to the backing surface of the film; such magnets further including in some instances a single, typically relative thin, magnet covering the entire backing surface of the sheet and, in additional instances, a plurality of individual and strategically placed magnets for use at specified perineter and interior locations of the specifically shaped film appliqué.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of a vehicle and illustrating first and second specifically configured sectional portions for masking, respectively, a hood and driver's side door of a vehicle such as is contemplated by a first variant of the present invention;

FIG. 2 is a sectional view exhibiting a reverse facing or backing surface of the hood sectional portion and upon which is applied an adhesive/tacking material such as is contemplated by the present invention;

FIG. 3a is a sectional view exhibiting a reverse facing or backing surface of the side door sectional portion and upon which are affixed thin layers of magnetic portions to secure the film in place upon the vehicle;

FIG. 3b is a view of a masking portion exhibiting a built-up or laminated border section, according to a further preferred variant of the present invention;

FIG. 4a is an assembly illustration of a sheet or roll of film upon which is employed a conventional numerically controlled die cut operation to quickly and effectively turn out the desired shaped sections;

FIG. 4b is an assembly illustration of a process in which a selected masking portion is created by low impact force (kiss) stamping press;

FIG. 4c is an assembly illustration of a succeeding process in which a masking portion is created by a rotary cutting die;

FIG. 4d is an illustration of a yet further assembly process in which a thin and magnetically adherent film layer is applied to an adhesively backed linen and in order to create a masking appliqué according to a further preferred variant;

FIG. 5 is a perspective illustration of a roll of adhesive or magnetic backed material according to a further preferred variant and which is capable of being sectioned into both smaller width rolls, and/or perforated to a desired length and/or cut to a desired length at a point of use;

FIG. 6a is an example of a first sectioned roll of material according to the present invention and which is capable of being unrolled and cut to a desired length;

FIG. 6b is an example of a second sectioned roll of material according to the present invention, again capable of being unrolled and cut to a desired length, and which also illustrates perforated and tear-away sections at selected intervals; and

FIG. 7 is a side view of a truck vehicle in a selected application and including a length of applied material corresponding to that withdrawn from a roll such as shown in FIGS. 6a and 6b and according to a specific TuTone painting process.

### DETAILED DESCRIPTION OF THE PREFERRED EMBODIMENTS

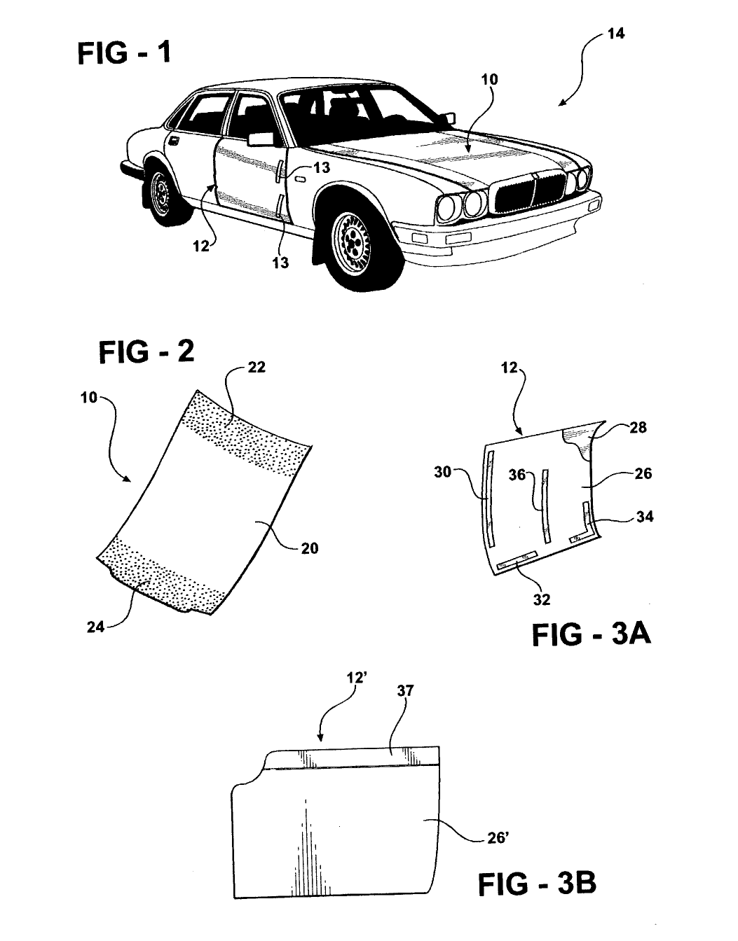

With reference now to FIG. 1, the present invention discloses a plurality of individual strips or sections of film, such as illustrated at 10 and 12, for use with associated hood and driver's side door locations of a typical vehicle 14. As previously described, the strips, again referenced by example at 10 and 12, are applied to associated portions of the vehicle 14 to mask them during painting of other and adjacent (uncovered) portions of the vehicle and without accidentally painting the masked portions, such as potentially occurring upon accidental overspray of paint by a robot or human operator.

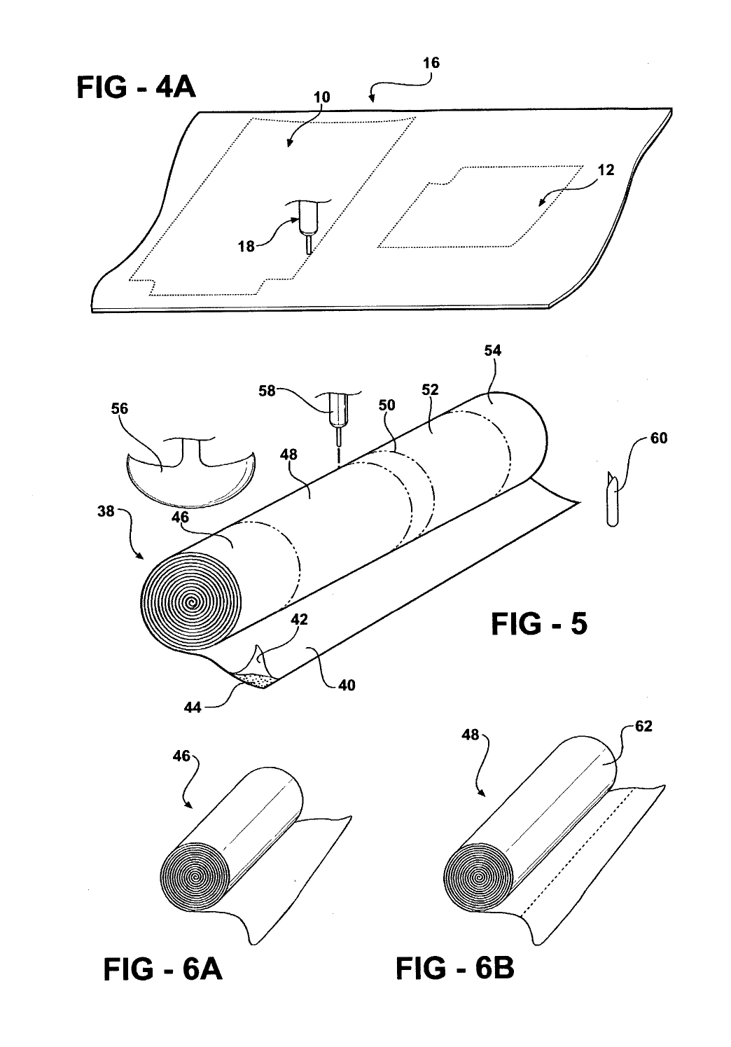

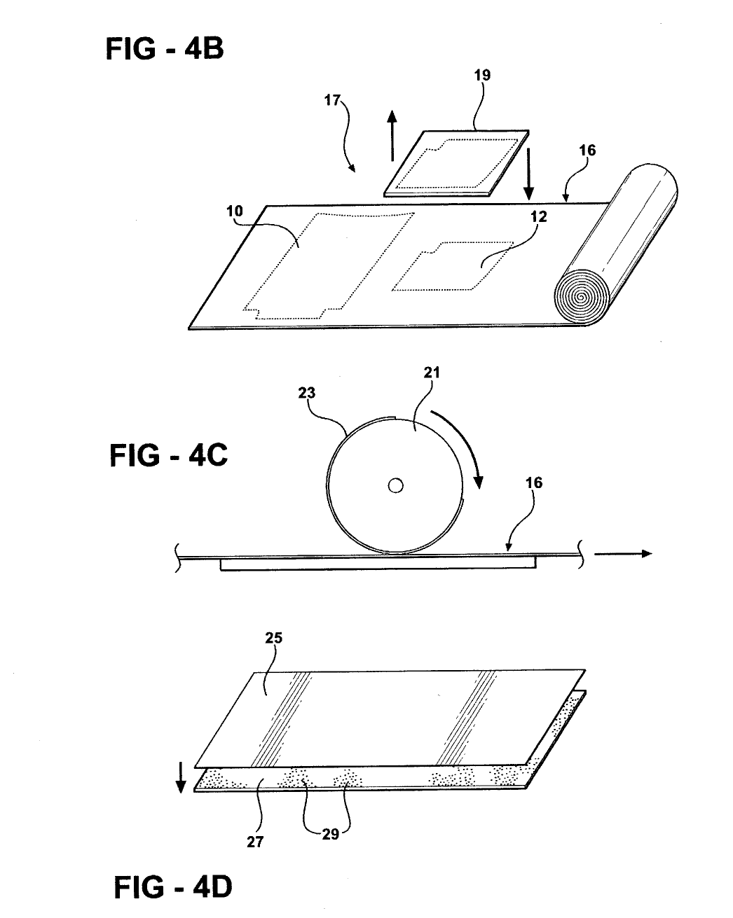

Referring to FIG. 4, a sheet (or roll) of the film illustrated generally at 16 and is constructed of a moisture impervious material, such as ideally a polypropylene or polyethylene material (or even another type of suitable material, such as having a rubberized construction and, in any event, a substantially impermeable nature) with a selected length and width, as well as a thickness preferably ranging between 1.0 mil to 6 mils. In a preferred application, the film may include a number of different materials exhibiting different thicknesses, among them including polyethylene, polypropylene, blends of both materials, and upon which may be applied any adhesive, including an acrylic-based or rubber-based adhesive.

Referring again to FIG. 1, the individual sections 10 and 12 are exhibited with the cross hatching indicating the plasticized construction of the film. Also shown in FIG. 1 are pull tabs, at 13 for section 12, and which facilitate the removal of the masking sections 10 and 12 from the vehicle 14. The pull tabs may be configured in any fashion desired to facilitate removal from the associated vehicle panel(s) and it is also envisioned that the design and placement of the tabs is such that it does not obstruct the adjacent and exposed portions of the vehicle upon which paint applications are desired.

Referring again to FIG. 1, the individual sections or strips of film may, in one variant, be cut to size to neatly fit over the associated body panels of the vehicle 14 and such as are referenced in phantom as the hood 10 and driver's side door 12 coverings. It is also understood that the strips or sections of the film material which are cut or otherwise patterned can correspond to any desired configuration of panel of the vehicle and are not limited to the shapes 10 and 12 and which are referenced only by example.

In one preferred application, and in order to maximize the effectiveness and efficiency of the invention, a conventional and numerically controlled die cut operation is employed. Referenced generally at 18 in FIG. 4a is a die cutter and which is fed instructions from a numeric controller (not shown) in order to quickly and effectively turn out the desired shaped sections 10 and 12 from a mat or roll 16 of material. It is however further understood that such die cut operations are fairly expensive to employ and are utilized only in certain applications.

With further regard to FIG. 4b, another option is illustrated at 17 and by which a process is employed to create a selected masking portion, again at 10 and 12, through the application of a low impact force (kiss) stamping press. In this illustration, a die 19 is provided and upon a bottom facing surface of which is established an outline of the portion 10, 12, etc., to be created. The die 19 is moved in successive downward/engaging and upward/retracting positions in order to section or cut out the desired part outline from the mat 16 of material.

Referring to FIG. 4c, an assembly illustration is shown in side view of a process by a rotary cutting die 21 is employed to section the desired masking section (again such as illustrated previously at 10 and 12) from a mat 16 of material. The rotary driven die 21 is positioned in such a manner that a desired cutting pressure (similar to that applied in the kiss stamping process of FIG. 4b) is applied to the mat 16. A cutting template 23 of the section 10 and 12 is applied along a given exterior circumferential area of the rotary driven die 21 and, upon continuous rotation of the die, causes a repetitive number of sections 10, 12, etc., to be sectioned from the mat 16.

FIG. 4d is an illustration of a yet further assembly process in which a thin and magnetically adherent film layer 25 is secured to a sheet of a cellulose-based substrate 27 upon which is applied an adhesive backing 29. The film layer 25 is secured to the substrate 27, by the adhesive 29, and operates to create a masking appliqué which can be adherently (magnetically) attracted to the selected vehicle panel. Alternatively, any other material having suitable properties can be employed as the substrate 27, among them including, without limitation, plastics, polypropylene, and polyethylene.

With reference to the preferred variant of FIGS. 5-7, to be further discussed, it is also envisioned that other film cutting and sectioning operations can be employed, such as cutting a given large number of standard sized and configured sections and for which the expense of a die cutting operation is unnecessary.

Referring to FIG. 2, a sectional view exhibits a reverse facing or backing surface 20 of the hood section 10 and upon which is applied an adhesive/tacking material, such as referenced at 22 and 24. The adhesive or tacking material is preferably a non-silicone material which is applied in strips or sections or, in other applications, impregnated into or coated onto some or all of the surface area defined by the backing surface 20 of the hood section 10 and so that, in use, it will not transfer to the painted surface of the vehicle.

Referring further to FIG. 3a, a sectional view exhibits a reverse facing or backing surface 26 of the side door 12 and upon which are affixed thin layers of magnetic portions, represented at 28, 30, 32, 34 and 36, to secure the film section 12 in place upon the vehicle 14. As with the adhesive material or appliqués, the magnetic portions may be glued or impregnated to the backing surface of the associated film section. Given further the relatively thin nature of the film covering (1-6 mils typically), it is also desired that the magnetically applied portions 28-36 also exhibit a fairly thin profile and so that they may both be economically applied and used with the film section 12 through the use of suitable heat rolling and/or adhesive applications.

In one given application, a single magnet (by example at 28) may extend so as to cover the entire backing surface 26 of the sheet or section 12. Alternatively, a plurality of individual and strategically placed magnets, as again referenced at 30, 32, 34 and 36 may have any desired configuration and be applied at given perimeter and/or interior locations of the specifically shaped film appliqué 12 in order to effectively apply the secure the film 12 upon the associated vehicle panel.

Referring to FIG. 3b, a view 12′ is shown of a side door panel masking section according to a further preferred variant. A selected backing surface 26′ is illustrated of the masking section, this typically having a thickness of 2 mil or greater. A border laminate section 37, typically having a dimension of 1-4 inches in width, is applied along at least one selected edge, such as along a top edge of the masking section. The border laminate section 37 can again be constructed of a polypropylene, polyethylene or blended material and may exhibit any desired thickness, such as 1-5 mil, and in order to establish a stronger/thickened edge location at the point of handling by a user. The laminate section can also be provided by a material having different characteristics than the masking section, such providing increased adhesive levels for rounding corners and adhering to panel edges, and further including softer materials to allow for easier cornering, or harder materials to allow for cleaner straight lines. Additional laminate sections may be applied along additional or all of the border locations of a given masking section and the masking section may be applied again with such as adhesives or magnetic adherent portions to the selected body panel or body portion of the vehicle. Also, other strips, in addition to laminated sections and including such as heat-sealed glued or tape applied strips of material may be utilized within the invention, in addition to any other suitable means for building up one or more border edges of a selected masking section.

Referring now to FIG. 5, a perspective illustration is shown at 38 of a roll of adhesive or magnetic backed material according to a further preferred variant. An unrolled portion of the roll is further illustrated at 40 and includes in some variants such as a peel-away paper or plastic strip 42 for revealing an adhesive 44 or other suitable tacking/adhering backing to the material. As also described previously, the roll can be provided with any desired width, but is preferably 5′ (feet) in width and, when wound, may contain upwards of 1500 linear feet or more of material.

As also described, the roll 38 is capable of being sectioned, into reduced width rolls such as are referenced at 46, 48, 50, 52 and 54 and separated by phantom lines extending therebetween. Tools Such as larger sized cutter guillotines 56 (for chopping entire width portions of rolls), laser cutters 58 (likewise capable of subdividing by width a section of the roll material) and conventional box cutter knives 60 (typically cutting to a desired length from an unwound roll portion of an entire roll 38 or selected subdivided roll 46-54) are employed within the scope of the invention and as alternatives to such as the die cutting operation previously discussed. Also, the roll may be perforated at given locations to facilitate sectioning/tear-off to a desired length. The perforations may also correspond to a given configuration of a masking section and which are removed and applied directly to a vehicle location.

Referring to FIG. 6a, an illustration is again made at 46 to a desired subdivided roll of material according to the present invention. As disclosed previously, the roll 46 of material is severed to a given width, such as 12″ by example, and so that it s capable of being unrolled and cut to a desired length.

As shown in FIG. 6b, an example of a second sectioned roll of material is again shown at 48 according to the present invention. As stated previously, the roll 48 is capable of being unrolled (such as at a width selected from dimensions including 15″ ) and cut to a desired overall length. As is also illustrated, perforated or tear-away sections (such as referenced in phantom at 62) can be provided at selected intervals (such as further defined at several foot increments along the length of the unwound roll and such as may correspond to a vehicle fender or side) and to provide a further option to quickly unrolling and sectioning a strip of the material for subsequent application.

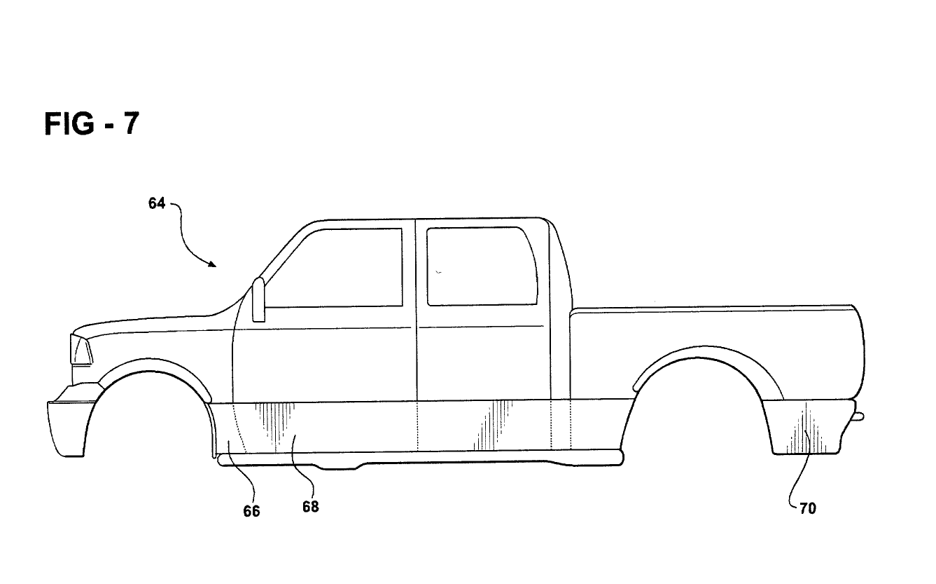

Referring finally to FIG. 7, a side view of a truck vehicle 64 is shown in a selected TuTone (two tone) painting application. One or more lengths of applied material, see at 66, 68 and 70, correspond to that withdrawn from a roll such as shown previously at 46 and 48. In the application of FIG. 7, the length or lengths of sectioned material are applied in masking fashion along the side of the vehicle 64, from its front to rear, and further proximate its bottom strip, which has been painted a first selected color. At that point, a second TuTone color may then be applied such as to the remaining body exterior of the vehicle and without the fear to over spraying the color previously applied upon the masked areas of the vehicle evidenced by the strips 66, 68 and 70.

As also discussed in the first preferred variant, the masking sections, such as also referenced at 10 and 12, may also be utilized to significantly improve the efficiently of two tone (TuTone) and other paint repair operations in addition to providing effective masking of unblemished vehicle portions during painting repair operations. As also discussed, the present invention will allow two tone painting operations to be accomplished utilizing a “wet on wet” process which can be easily applied and which will impart a relatively thin “break line” between the adjoining colors.

A method for masking portions of a vehicle is also disclosed and includes the steps of providing the sheet or roll of film material, die cutting or otherwise sectioning specifically shaped outlines or roll widths to match corresponding sections or panels of the vehicle, applying or impregnating the adhesive tacking material or magnetic appliqués to the backing surface of the selected film section, and applying the film section over the desired vehicle panel.

In view of the foregoing, it is to be understood that numerous modifications and variations of the present invention may be implemented. The foregoing discussion and description is illustrative of specific embodiments of the invention, but is not meant to be a limitation upon the practice thereof. It is the following claims, including all equivalents, which define the scope of the invention.

I claim:

1. A plurality of masking sections applied to portions of a vehicle to mask the same during painting of other and adjacent portions of the vehicle, comprising:
each of said plurality of individual sections being constructed of a plasticized material having a specified shape and thickness and including a backing surface; and
said backing surface being adherently applied to a specified location of the vehicle and in order to mask a surface of the vehicle at that location.

2. The masking sections of claim 1, said masking sections being sectioned from a roll of material, each of said masking sections further exhibiting a specified shape and size and being constructed of a water impervious and plasticized material.

3. The masking sections of claim 2, said masking sections each being composed of a material including at least a polypropylene, polyethylene and blends thereof and exhibiting at least an acrylic and a rubber adhesive backing.

4. The masking sections of claim 1, further comprising an adhesive material applied to said backing surface of each of said masking sections.

5. The masking sections of claim 1, further comprising at least one magnetic portion applied to said backing surface of each of said marking sections.

6. The masking sections of claim 4, further comprising a peel-away layer applied to said backing surfaces.

7. The masking sections of claim 4, further comprising a film material adhesively applied to a cellulose-based substrate.

8. The masking sections of claim 1, further comprising creating a two tone painting application of a specified vehicle portion.

9. The masking section of claim 1, further comprising a strip applied along at least one border of a given section.

10. A method for masking portions of a vehicle to mask the same during painting of other and adjacent portions of the vehicle, said method comprising the steps of:
providing a substantially elongated and widened sheet of film material exhibiting a specified length, width and thickness;
cutting at least one specifically shaped film section of said sheet exhibiting an outline to match a corresponding panel of the vehicle; and
adherently applying a backing surface of each of said sections to the corresponding location of the vehicle and in order to mask a surface of the vehicle at that location.

11. The method of claim 10, further comprising the step of applying an adhesive material to said backing surface of each of said film sections.

12. The method of claim 11, further comprising the step of applying at least one magnetic strip or appliqué to said backing surface of each of said die cut sections.

13. The method of claim 10, further comprising the step of providing said substantially elongated and widened sheet of film material as a roll of material.

14. The method of claim 12, further comprising the step of applying a peel away layer to a backing surface associated with said roll of material.

15. The method of claim 14, further comprising the step of perforating along a width running direction of said roll of material at predetermined length intervals.

16. The method of claim 10, said step of cutting further comprising the step of kiss stamping said specifically shaped section from said sheet of film material.

17. The method of claim 10, said step of cutting further comprising the step of employing a die roller for sectioning said specific film shape from said sheet of film material.

19. The method of claim 10, further comprising the step of adhesively applying said film material to a linen substrate.

20. The method of claim 10, further comprising the step of creating a two tone painting application utilizing said masking portions.

21. The method of claim 10, further comprising the step of applying a laminate section along at least one border location of a masking portion.
